(19) United States
(12) Patent Application Publication
(10) Pub. No.: US 2010/0284170 A1
(43) Pub. Date: Nov. 11, 2010

(54) LIGHT DIFFUSER PLATE AND PROCESS FOR PRODUCTION OF LIGHT DIFFUSER PLATE

(76) Inventors: Toshio Awaji, Suita-shi (JP); Yasutaka Nakatani, Suita-shi (JP); Kazuyuki Sugihara, Sanda-shi (JP); Takehisa Kishimoto, Sanda-shi (JP); Akira Ueda, Sanda-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/743,951

(22) PCT Filed: Nov. 25, 2008
(86) PCT No.: PCT/JP2008/071298

§ 371 Date: May 20, 2010

(30) Foreign Application Priority Data
Dec. 4, 2007 (JP) 2007-313904

(51) Int. Cl. G02F 1/13357; G02B 5/02; B32B 38/00; B32B 37/24; B32B 37/02

(52) U.S. Cl. 362/97.1; 359/599; 156/229

(57) ABSTRACT

The problem to be solved by the present invention is to provide a light diffuser plate and a process for production thereof, which light diffuser plate can diffuse light selectively in any desired direction even when the number of cold cathode fluorescent lamps as backlights is reduced and the gap between cold cathode fluorescent lamps is increased, so suppressing luminance unevenness and lamp image with good repeatability in stable way and maintaining high luminance. The present invention is also aimed at providing a backlight unit that possesses similar characteristics. The light diffuser plate of the present invention is characterized in comprising a light diffusion layer containing a thermoplastic resin and a crosslinked organic fine particle dispersed in the thermoplastic resin, and a cylindrical lens array on at least one side; wherein a refractive index of the crosslinked organic fine particle is different from a refractive index of the thermoplastic resin; a crosslink density defined by the formula (1) of a polymer constituting the crosslinked organic fine particle is within the predetermined range; an aspect ratio of the crosslinked organic fine particle is more than 1; and a major-axis direction of the crosslinked organic fine particle and a length direction of the cylindrical lenses are the same.

### TECHNICAL FIELD

The present invention relates to a light diffuser plate, a process for production of the light diffuser plate, and a backlight unit containing the light diffuser plate.

### BACKGROUND ART

In recent years, display devices have been shifted from those using CRT (Cathode Ray Tubes) to those using LCD technology, and screen size thereof has become larger. There are two types of LCD display backlight design: the edge light type and the direct backlight type. For large LCD display devices, a direct backlight, in which an array of multiple cold cathode fluorescent lamps (CCFLs) is used as a light source, has been generally used.

LCD device screens that use direct backlights are bright in the parts where cold cathode fluorescent lamps (CCFLs) are present, but are relatively dark in other parts. This causes problems with unevenness of the luminance. In addition, the CCFLs are projected onto the screen. To counter the problems, attempts have been made to diffuse the light emitted by CCFLs evenly across the entire screen by incorporating a light diffuser plate between the CCFLs and the LCD panel.

Currently, the approach to effective reduction of the unevenness in luminance and to enhancement of light evenness is to stack several layers of prism sheet and micro-lens sheets on a light diffuser plate. However, such a method gets cost as more sheets are used. In addition, the sheets have to be installed manually in a clean room, so staff costs are also raised.

There is also a requirement to reduce the thickness of LCDs, which means that the distance between cold cathode fluorescent lamps (CCFLs) and screen have to be reduced, and light is difficult to be diffused. The number of CCFLs is also being cut in order to keep costs down. As a result, the unevenness in luminance has become a bigger problem. Accordingly, the development of a light diffuser plate which has superlative optical diffusion properties has been needed.

For example, an optical sheet which has a prism part in at least one surface and in which a dispersion phase is dispersed within a continuous, phase is disclosed in JP 2007-206569 A, as a light diffuser plate which is aimed at reducing luminance unevenness and at enhancing luminance. The dispersion phase is feasible to diffuse the light emitted from cold cathode fluorescent lamps in the direction of the plate surface, since the refractive index of the dispersion phase is different from that of the continuous phase. In addition, the light is further diffused by the prism formed on the surface. It is described that the dispersion phase is either mutually insoluble or hardly-soluble with the continuous phase, the shape of the dispersion phase change into a rugby ball shape when the sheet is drawn or when stretched along one axis, and the sheet therefore shows anisotropy. It is described in the Examples that a dispersion phase composed of polystyrene resin is added and dispersed along with a compatibilizing agent into a polypropylene resin and then extruded in a drawing ratio of roughly three times, so that the shape of the polystyrene resin dispersion phase becomes like a rugby ball.

### DISCLOSURE OF THE INVENTION

### Problems to be Solved by the Invention

As described above, it is known that there is a light diffuser plate used in LCD devices which light diffuser plate has prisms formed on the surface and in which particles having anisotropic characteristics are assumed to be dispersed into a matrix resin.

However, from the view of the present inventors; even particles of resins said to be insoluble or hardly-soluble in a matrix resin cannot retain the original shape when the particles are dispersed into the heated and melted matrix resin so long as the particles are normal organic resin particles. As a result, a clear boundary necessary for refracting light between the continuous phase and the dispersion phase cannot be attained, and the dispersion phase with the desired shape or size distribution cannot be reliably obtained. Therefore, luminance evenness cannot be sufficiently improved. It is described in JP 2007-206569 A that such particles can be composed of inorganic substance such as silica. However, even if inorganic particles are crushed into powder form inside a matrix resin, it is inconceivable that the shape of such particles is changed so as to exhibit anisotropic characteristics. It is clear from the point that the in-depth consideration to the anisotropic properties of particles is not given with the technologies described in the publication.

The problem to be solved by the present invention is to provide a light diffuser plate and a process for production thereof, which light diffuser plate can diffuse light selectively in any desired direction even when the number of cold cathode fluorescent lamp (CCFL) in a backlight unit is reduced and the gap between CCFLs is increased, so suppressing luminance unevenness and lamp image with good repeatability in stable way and maintaining high luminance. The present invention is also aimed at providing a backlight unit that possesses similar characteristics.

### Means for Solving the Problems

The inventors carried out careful research aimed at finding a solution to the problems mentioned above. As a result, it was clarified that, with the conventional method described above, sufficient light diffusion anisotropy property cannot be improved even if a thermoplastic resin sheet is drawn, since the shape of the organic particles contained within the sheet do not change into the desired shape. In other words, organic particles of which the molecules are not crosslinked either are dissolved or deformed in the molten matrix resin when the particles are dispersed into the molten matrix resin. Accordingly, it is impossible that the organic particles cannot be fashioned into the desired shape, distribution or orientation degree by drawing of the sheet. On the other hand, the shape of the organic particles made from resin which is excessively crosslinked or inorganic particles is not changed at the dispersion stage into the matrix resin; however, the desired light anisotropic property cannot be obtained, since the shape of the particles is not changed even in drawing process. The present inventors therefore completed the present invention by finding that if organic particles which is appropriately crosslinked are used, a high degree of light diffusion anisotropy can be obtained since the particles are deformed and oriented in the direction of the drawing due to such factors as shear during the drawing process, but the particles is not deformed during the process of dispersion into the matrix resin.

The light diffuser plate according to the present invention is characterized in comprising a light diffusion layer containing a thermoplastic resin and a crosslinked organic fine particle dispersed in the thermoplastic resin, and a cylindrical lens array on at least one side;

wherein,

a refractive index of the crosslinked organic fine particle is different from a refractive index of the thermoplastic resin;

a crosslink density defined by a following formula (1) of a polymer constituting the crosslinked organic fine particle is not less than 0.001% and not more than 0.12%:

$$Crosslink density ( \% ) \frac{\{ Fn ( c ) / Mw ( c ) \} \times \{ W ( c ) \} \times 100}{W ( m ) + W ( c )} \qquad ( 1 )$$

wherein Fn(c) is the number of a crosslinkable functional group of a crosslinking agent used for producing the crosslinked organic fine particle; Mw(c) is a molecular weight of the crosslinking agent used for producing the crosslinked organic fine particle; W(c) is mass % of the crosslinking agent used for producing the crosslinked organic fine particle, relative to a total of a monomer used for producing the crosslinked organic fine particle and the crosslinking agent; W(m) is mass % of the monomer, relative to the total of the monomer and the crosslinking agent;

an aspect ratio of the crosslinked organic fine particle is more than 1; and

a major-axis direction of the crosslinked organic fine particle and a length direction of the cylindrical lenses are the same.

The process for production of a light diffuser plate according to the present invention is characterized in comprising steps of:

dispersing a crosslinked organic fine particle in a thermoplastic resin, wherein a crosslink density defined by a following formula (1) of the crosslinked organic fine particle is not less than 0.001% and not more than 0.12%, and a refractive index of the crosslinked organic fine particle is different from a refractive index of the thermoplastic resin,

$$Crosslink density ( \% ) \frac{\{ Fn ( c ) / Mw ( c ) \} \times \{ W ( c ) \} \times 100}{W ( m ) + W ( c )} \qquad ( 1 )$$

wherein Fn(c) is the number of a crosslinkable functional group of a crosslinking agent used for producing the crosslinked organic fine particle; Mw(c) is a molecular weight of the crosslinking agent used for producing the crosslinked organic fine particle; W(c) is mass % of the crosslinking agent used for producing the crosslinked organic fine particle, relative to a total of a monomer used for producing the crosslinked organic fine particle and the crosslinking agent; W(m) is mass % of the monomer, relative to the total of the monomer and the crosslinking agent;

forming the dispersion into a sheet;

forming a cylindrical lens array on at least one side of the sheet; and

uniaxially-stretching the sheet in the same direction as a length direction of the cylindrical lenses.

The backlight unit according to the present invention is characterized in comprising the light diffuser plate according to the present invention and a cold cathode fluorescent lamp;

wherein the light diffuser plate and the cold cathode fluorescent lamp are positioned to match a length direction of the cylindrical lenses with a length direction of the cold cathode fluorescent lamp.

### MODE FOR CARRYING OUT THE INVENTION

Hereinafter, the structure of the light diffuser plate according to the present invention is explained; and then the process for production thereof is explained.

The light diffuser plate according to the present invention is characterized in comprising a light diffusion layer containing a thermoplastic resin and a crosslinked organic fine particle dispersed in the thermoplastic resin, and a cylindrical lens array on at least one side;

wherein,

a refractive index of the crosslinked organic fine particle is different from a refractive index of the thermoplastic resin;

a crosslink density defined by a following formula (1) of a polymer constituting the crosslinked organic fine particle is not less than 0.001% and not more than 0.12%:

$$Crosslink density ( \% ) \frac{\{ Fn ( c ) / Mw ( c ) \} \times \{ W ( c ) \} \times 100}{W ( m ) + W ( c )} \qquad ( 1 )$$

wherein Fn(c) is the number of a crosslinkable functional group of a crosslinking agent used for producing the crosslinked organic fine particle; Mw(c) is a molecular weight of the crosslinking agent used for producing the crosslinked organic fine particle; W(c) is mass % of the crosslinking agent used for producing the crosslinked organic fine particle, relative to a total of a monomer used for producing the crosslinked organic fine particle and the crosslinking agent; W(m) is mass % of the monomer, relative to the total of the monomer and the crosslinking agent;

an aspect ratio of the crosslinked organic fine particle is more than 1; and

a major-axis direction of the crosslinked organic fine particle and a length direction of the cylindrical lenses are the same.

The light diffusion layer of the light diffuser plate according to the present invention contains a crosslinked organic fine particle dispersed in a thermoplastic resin, and can diffuse light in the desired direction.

The thickness of the light diffusion layer can be adjusted where necessary so is not subject to any particular restrictions, but generally the thickness may be adjusted between not less than 0.3 mm and not more than 10 mm. If the thickness is less than 0.3 mm, the optical diffusion property may not be sufficiently obtained, and occasionally a stable shape may not be maintained due to the lack of rigidity. On the other hand, if the thickness is more than 10 mm, a complete device incorporating the light diffuser plate of the present invention may not be compact enough. The thickness is more preferably not less than 0.5 mm and not more than 5 mm.

The kind of the thermoplastic resin constituting the matrix of the light diffusion layer of the light diffuser plate according to the present invention is not subject to any particular restrictions, as long as the thermoplastic resin is transparent and has adequate strength as a main constituent element of the light diffuser plate. For example, polycarbonate resins; acrylate resins such as polymethylmethacrylate; polystyrene resins such as polystyrene, polyvinyltoluene, poly(p-methylstyrene); MS resins, which is a copolymer of metylmethacrylate and styrene; norbornene resins; polyallylate resins; polyether sulfone resins; mixed resins of the 2 or more resins; and the like can be used. Preferably, polycarbonate resins, polystyrene resins and norbornene resins may be used. Among the resins, polycarbonate resins are especially preferable for a light diffuser plate, since the resin is excellent in transparency, heat resistance property and processability, and has a good balance of the properties.

The thermoplastic resin described above is exemplified as a component of the structure of the light diffusion layer, but can be used as a resin for the structural components of other layers too, since transparency and so on are required for other layers too.

A crosslinked organic fine particle with light diffusion property is dispersed into a transparent thermoplastic resin in the light diffusion layer of the light diffuser plate according to the present invention. The term, “dispersion”, means that the crosslinked organic fine particle does not aggregated enough to prevent the passing of light, and is dispersed as evenly as possible so that the light diffusion property is obtained across the entire light diffusion layer.

The ratio of the thermoplastic resin and the crosslinked organic particle can be adjusted as appropriate. For example, the crosslinked organic fine particle not less than 0.1 part by mass and not more than 5.0 parts by mass can be added to 100 parts by mass of the thermoplastic resin. If less than 0.1 part by mass of the crosslinked organic particle is added relative to 100 parts by mass of the thermoplastic resin, luminance evenness may not be sufficiently improved. On the other hand, if the ratio exceeds 5.0, the transparency of the light diffusion layer may fall, and the luminance itself may drop.

As the monomer used as the raw material for the crosslinked organic particle, (meth)acrylates such as (meth)acrylic acid, methyl (meth)acrylate, ethyl (meth)acrylate, n-propyl (meth)acrylate, iso-propyl (meth)acrylate, n-butyl (meth)acrylate, iso-butyl (meth)acrylate, t-butyl (meth)acrylate, 2-ethylhexyl (meth)acrylate, cyclohexyl (meth)acrylate, benzyl (meth)acrylate, hydroxyethyl (meth)acrylate, hydroxypropyl (meth)acrylate; stylenes such as stylene, p-methylstylene, vinyltoluene, p-t-butylstylene; maleimides such as N-phenylmaleimide, N-cyclohexylmaleimide, N-benzylmaleimide; (meth)acrylamides such as (meth) acrylamide, N-methylol(meth)acrylamide; acrylonitriles such as (meth)acrylonitrile; N-vinylpyrrolidone; and the mixed monomer of the above 2 or more monomers can be used.

As the crosslinking agent used as the raw material for the crosslinked organic particle, multifunctional (meth)acrylates such as ethylene glycol di(meth)acrylate, diethylene glycol di(meth)acrylate, propylene glycol di(meth)acrylate, neopentyl glycol di(meth)acrylate, trimethylolpropane tri(meth)acrylate, bishydroxyethyl bisphenol A di(meth)acrylate; radical polymerization crosslinking agents such as divinyloxyethoxy(meth)acrylate, diallyl phthalate, ally (meth)acrylate, divinylbenzene; multifunctional epoxy compounds such as bisphenol A diglycidyl ether, diethylene glycol diglycidyl ether, neopentyl glycol diglycidyl ether; multifunctional isocyanate compounds such as tolylene diisocyanate, xylylene diisocyanate, isophorone diisocyanate; multifunctional methylol compounds such as N-methylol melamine, N-methylol benzoguanamine; and the mixed monomer of the above 2 or more agents can be used.

The refractive index of the crosslinked organic particle according to the present invention is set so as to differ from the refractive index of the thermoplastic resin which forms the light diffusion layer. If crosslinked organic particle with an identical refractive index is used, light is not refracted and therefore luminance evenness cannot be sufficiently improved. On the other hand, the refractive indices of resins differ according to the kind of the resin, so different kinds of resins for the crosslinked organic particle and the thermoplastic resin may be selected. However, in order to ensure that the light diffusion anisotropic property is obtained, it is preferable to keep the difference in refractive indices of the thermoplastic resin and the crosslinked organic particle at not less than 0.03.

Antioxidizing agent may also be added to at least one of either the crosslinked organic particle or the thermoplastic resin, of the present invention. Antioxidizing agent can suppress coloration of the crosslinked organic particle and the thermoplastic resin through oxidation or deterioration during heating and forming, thereby assuring enhanced luminance of the backlight unit using the light diffuser plate of the present invention.

A conventionally known antioxidizing agent can be used. For example, hindered phenol antioxidizing agents such as pentaerythritoltetrakis[3-(3,5-di-t-butyl-4-hydroxyphenyl)propionate] and octadecyl-3-(3,5-di-t-butyl-1-hydroxyphenyl)propionate; phosphorous antioxidizing agents such as tris(2,4-di-t-butylphenyl)phosphite and tris[2-[[2,4,8,10-tetra-t-butyldibenzo[d,f][1,3,2]dioxaphosphine-6-yl]oxy]ethyl]amine; sulfur antioxidizing agents such as thiodiethylenebis[3-(3,5-di-t-butyl-4-hydroxyphenyl)propionate] as an antioxidizing agent having an aromatic ring and pentaerythrityltetrakis(3-laurylthiopropionate) as an antioxidizing agent without an aromatic ring; lactone antioxidizing agents such as a reaction product of 3-hydroxy-5,7-di-t-butyl-furan-2-on and o-xylene; hydroxyamine antioxidizing agents such as an oxidation product of alkylamine of which raw material is a reduced beef tallow; vitamin E antioxidizing agents such as 3,4-dihydro-2,5,7,8-tetramethyl-2-(4,8,12-trimethyltridecyl)-2H-benzopyran-6-ol; and the like can be used.

The use amount of antioxidizing agent can be adjusted as required, but generally, the amount may be between about not less than 0.005 mass % and not more than 0.3 mass % relative to the entire of the crosslinked organic particle and/or the thermoplastic resin.

Aside from the use an appropriate amount of crosslinking agent, the crosslinked organic particle of the present invention can be produced in accordance with general polymer producing processes. For example, crosslinked organic particle composed of methacrylate can be produced by adding a monomer and a crosslinking agent to a water-based solvent containing a surfactant, advancing the reaction by heating after further adding a radical polymerization reaction initiator such as peroxides, and recovering by filtration and drying the obtained compound. The use ratio of the monomer and crosslinking agent can be adjusted in accordance with the crosslinking density, explained below.

It is preferable to adjust the softening temperature of the crosslinked organic particle so that the temperature is lower than the softening temperature of the thermoplastic resin by checking the kind of the monomer to be used as the raw material and the quantity of the crosslinking agent. The crosslinked organic particle of the present invention is crosslinked to an appropriate degree such that even if the softening temperature is low, the particle does not dissolve into the thermoplastic resin nor easily change shape when the particle is dispersed into the resin. On the other hand, if the softening temperature is lower than that of the thermoplastic resin, the spherical or quasi-spherical organic particle easily changes shape during the drawing process, resulting in greater light diffusion anisotropy of the light diffuser plate.

The crosslinked organic particle of the present invention is comprised of a crosslinked polymer that has a crosslink density defined by the above formula (1) of not less than 0.001% and not more than 0.12%. If the crosslink density is less than 0.001%, it may possibly be impossible to change the shape of the particle into the desired shape while being oriented during drawing process since the particle may be melted and deformed when the particle is dispersed into molten thermoplastic resin, and to achieve sufficient luminance evenness. Moreover, repeatability of luminance evenness may be possibly reduced when the molding conditions are subject to even small change. If, on the other hand, the crosslink density exceeds 0.12%, the strength of the crosslinked polymer becomes excessive so that even if deformation during dispersion process may be kept under control, light diffusion anisotropy may be difficult to be obtained in the desired direction since the shape of the crosslinked polymer particle may not be changed during drawing process. The crosslink density is therefore preferably not less than 0.005% and not more than 0.11%, and more preferably not less than 0.01% and not more than 0.10%.

As the formula (1), the crosslink density can be adjusted by altering the use amount of monomer and crosslinking agent during the production of the crosslinked polymer particle, and by altering either the molecular weight or the number of functional groups that have crosslinking property of the crosslinking agent. For example, if a crosslinking agent with many functional groups with crosslinking property per molecule is used, the crosslink density is increased since many more polymers can be crosslinked.

The aspect ratio of the crosslinked organic particle in the light diffuser plate of the present invention is greater than 1. The shape of the crosslinked organic particle which is spherical or almost spherical at the raw material stage is changed into, for example, an oval shape due to shear forces and so on during drawing process. However, it is thought that the crosslinked organic particle does not necessarily have an oval shape in the strict sense, but in reality has a variety of elongated shapes. Accordingly, the aspect ratio of the present invention refers to the ratio of the longest part to the shortest part of the entire crosslinked organic particle shapes within an area of 100 μm×100 μm at the center and at a distance of 1/10^{th} of the width of the light diffuser plate from the edges when 1) the light diffuser plate is viewed from a vertical direction and 2) in the cylindrical lenses' longitudinal direction, that is, when viewed from the shear cross-section aligned with the direction of draw.

As a desirable average aspect ratio for the cross-linked organic particles dispersed into the light diffusion layer is preferably not less than 1.1. The greater the aspect ratio is, the greater the light diffusion anisotropy of the light diffuser plate is. On the other hand, in order to increase the aspect ratio, it is necessary to increase the drawing ratio of the light diffuser plate, but this incurs the risk of lowering the strength of the light diffuser plate, so the aspect ratio is preferably not more than 5.0.

The longitudinal axis of the crosslinked organic particle in the light diffuser plate of the present invention is in the lengthwise direction of the cylindrical lenses, in other words, in the same as drawing direction. This is attributed to the result of aligning the drawing direction and the longitudinal direction of the cylindrical lenses during the production process by making the light diffuser plate into sheet form and drawing the sheet after dispersing the spherical or quasi-spherical crosslinked organic particle into the thermoplastic resin. The orientation of the light diffuser plate according to the present invention allows light to be diffused in the desired direction. The two directions referred to the above as identical are not restricted to a case where both directions are exactly identical, and also include the case of substantively identical. Specifically, the identical directions of both referred to the above mean that the angles subtended between the longitudinal axis of the crosslinked organic particle within an area of 100 μm×100 μm at the center and at a distance of 1/10^{th} of the width of the light diffuser plate from the edges and the longitudinal direction of the cylindrical lenses are not more than 30 degrees at most, preferably not more than 20 degrees, and more preferably not more than 10 degrees, when 1) the light diffuser plate is viewed from the vertical direction and 2) viewed from the shear cross-section aligned with the longitudinal direction of the cylindrical lenses.

A group of cylindrical lenses is formed on at least one of the surfaces of the light diffuser plate of the present invention. The cylindrical lenses of the present invention refer to lenses which are different from normal lenses in a way that the lenses are somewhat long and have cross sections in the shape of isosceles triangles and the like, and either diffuse or gather the incident light within a set viewing angle. The size of the cylindrical lenses is not particular restricted, and the most appropriate size for the task may be selected. For example, the widths of the lenses can be not less than about 50 μm and not more than about 400 μm, the heights can be not less than about 10 μm and not more than about 200 μm, and the lengths can be identical with the length of the light diffuser plate or the same length minus the edges. The cross-sectional shapes thereof are also not restricted so long as light can be diffused perpendicular to the lenses' longitudinal direction. Examples of the possible shapes include isosceles triangles, semi-circles, radial shapes, parts of oval shapes or lenses with the lower portion a rectangle and the upper portion in semi-circular shape. The angle of the apex of an isosceles triangle can be not less than 60 degrees and not more than 130 degrees. The center angle of the semi-spherical lenses is not restricted to 180 degrees, and may be selected so as to diffuse light in a particular direction.

Multiple cylindrical lenses are formed on at least one surface of the light diffuser plate according to the present invention. It is feasible to leave a gap between one lens and the neighbor lens, but preferably no gap is left since the efficiency of the optical diffusion is thereby enhanced. Although the cylindrical lenses can be formed right up to the edges, the edges can also be left flat in order to leave a space for fixing.

The resin for constituting the cylindrical lenses can be the same as that used for the matrix resin of the light diffusion layer, or different resin can be used, but generally the same resin is selected. Moreover, the same crosslinked organic particle dispersed into the light diffusion layer can also be dispersed into the thermoplastic resin that constitutes the cylindrical lenses. The longitudinal direction of the cross-linked organic particle should be aligned with the lengthwise axes of the cylindrical lenses.

On the reverse side to the side of the light diffuser plate according to the present invention, on which side the cylindrical lenses are formed, a layer which includes an ultraviolet (UV) absorption agent, a layer which contains an anti-static agent, or a layer which includes both of an UV absorption agent and an anti-static agent can be formed. In other words, a layer which has properties other than of diffusing light may be formed on at least one of the surfaces of the optical diffusion layer. The use of the term “one of the surfaces” means that layers having differing functions may not necessarily be formed directly over the optical diffusion layer, and for example, it is acceptable to stack several layers such as a UV absorption layer and an anti-static layer on one surface of the optical diffusion layer. The layers with differing functions are attached to the light diffuser plate of the present invention, in order to reduce the UV emitted by the light emitting body and suppress the discoloration of the light diffuser plate. The layers also help to suppress static, prevent a reduction in luminance through the accumulation of dust, and extend the life of the electronic device.

Conventional UV absorption agents and anti-static agents may be used. For example, any of the following may be used as a UV absorption agent: salicylic acid phenol ester UV absorption agents; benzophenone UV absorption agents; triazine UV absorption agents; benzotriazole UV absorption agents; cycliciminoester UV absorption agents; hybrid UV absorption agents that have an inter-molecular hindered structure or hindered amine structure; low molecular weight UV absorption agents such as triphenyl cyanoacrylate UV absorption agents; and polymer UV absorption agent in which the low density polymer UV absorption agents are bonded in such a way that the agents are hanging off the polymers, such as HALSHYBRID® manufactured by Nippon Shokubai Co., Ltd.

As an antistatic agent, olefin sulfate esters and metallic salts thereof, such as alkylsulfonic acid, alkylenzenesulfonic acid, and salts thereof with Li, Na, Ca, Mg, Zn; anion surfactants such as phosphate esters of higher alcohol; cation surfactants such as tertiary amine, quaternary ammonium salt, cation acrylic acid ester derivative, cation vinyl ether derivative; ampholytic surfactants such as ampholytic salt of alkylaminebetaine, ampholytic salt of carboxylic acid alanine or sulfonic acid alanine, ampholytic salt of alkylimidazoline; nonionic surfactants such as ester of fatty acid and polyalcohol, and alkylamine bonded with polyoxyethylene; polyamideelastomers such as polyether ester amide and polyesteramide. In addition, conductive resins such as polyvinylbenzyl cation resin and polyacrylic acid cation resin can be used as an antistatic agent.

The use amounts of a UV absorption agent and an anti-static agent can be adjusted according to the particular intended function. The amount is generally 1 to 50 parts by mass relative to 100 parts by mass of the resin which constitutes each layer.

In order to form the layers having the differing functions, the sheets into which a UV absorption agent or an anti-static agent is homogenously dispersed within a thermoplastic resin in a manner similar to the light diffusion layer may be bonded to the light diffusion layer by heat-crimping or by using adhesives. Alternatively, a paste containing a UV absorption agent or other agents may be spread onto the light diffusion layer and then dried or cooled. In addition, the thermoplastic resins impregnated with a light diffusion agent may be extruded together with thermoplastic resin that is impregnated with a UV absorption agent or an anti-static agent.

The thickness of the layers having the differing functions may be adjusted in accordance with the specific function, but generally, can be about 1 to 50 μm.

The size and shape of the light diffuser plate of the present invention is not particular restricted. For example, the size and shape can be adjusted to fit those of LCD devices.

The process for production of a light diffuser plate according to the present invention is characterized in comprising steps of:

dispersing a crosslinked organic fine particle in a thermoplastic resin, wherein a crosslink density defined by the above-mentioned formula (1) of the crosslinked organic fine particle is not less than 0.001% and not more than 0.12%, and a refractive index of the crosslinked organic fine particle is different from a refractive index of the thermoplastic resin;

forming the dispersion into a sheet;

forming a cylindrical lens array on at least one side of the sheet; and

uniaxially-stretching the sheet in the same direction as a length direction of the cylindrical lenses.

In the method of the present invention, the crosslinked organic particle composed of polymers having a crosslink density based on the above-mentioned formula (1) of not less than 0.001% and not more than 0.12% and a refractive index which differs from that of the relevant thermoplastic resin is dispersed into a transparent thermoplastic resin.

The crosslink density of the crosslinked organic particle can be adjusted by altering the amount of a monomer and a crosslinking agent, the molecular weight and the number of functional groups with cross-linking property of the crosslinking agent during the production process of the crosslinked organic particle, as mentioned above. More specifically, the appropriate amounts of a monomer and a crosslinking agent to be used are dissolved or diffused in a solvent, and then a polymerization initiator such as peroxide is added, in order to proceed a polymerization reaction. A surfactant may be used at the reaction in order to improve the solubility or dispersability of the monomer. The solvent can be selected as appropriate, and for example, a water-based solvent such as de-ionized water may be used. The concentration of the monomer and the like in the reaction mixture, reaction temperature and reaction time can be adjusted as appropriate by using preparatory trials or measuring the progress of actual reactions as references.

The average diameter of the crosslinked organic particle is preferably not less than 0.5 μm and not more than 100 μm. This is because if the average diameter of the crosslinked organic particle is either too small or too big, a sufficient light diffusion property may not be obtainable. The average particle diameter is more preferably not less than 0.8 μm and not more than 80 μm, and especially preferably not less than 1 μm and not more than 50 μm. The average particle diameter can be measured with the normal method. For example, Beckman Coulter's precision granularity distribution measuring devices such as the Multisizer III can be used to measure the granularity distribution of a reference number of particles, and the median diameter is derived from the resulting granularity distribution.

Generally accepted methods for dispersing the crosslinked organic particle into the thermoplastic resin can be used. For example, the crosslinked organic particle can be added to the thermoplastic resin after the particle is heated over the melting temperature thereof and softened, and the mixture is stirred and mixed. The crosslinked organic particle of the present invention is crosslinked to an appropriate level so the particle does not be dissolved in the thermoplastic resin. However, it is possible that the crosslinked organic particle may deform depending on the crosslink density if overheated, so the heating temperature may be preferably set to in a range of between the melting temperature+approximately 5 to 50 degrees.

Next, the obtained dispersion is formed into a sheet. A forming method is not particularly restricted, but preferably an extrusion method is used since the crosslinked organic particle may be possibly deformed or melted with a casting process. In other words, the dispersion is melted and then formed into a sheet by extrusion.

In addition, it is possible to combine the process by which the crosslinked organic particle is dispersed in the transparent thermoplastic resin and the sheet forming process into a single process by heating and mixing the transparent thermoplastic resin and other raw materials in the extrusion machine.

A set of cylindrical lenses is then formed on at least one of the surfaces of the resulting sheet, and the sheet is drawn along one axis in the same direction as the longitudinal axes of the cylindrical lenses. The processes may be carried out in any order, or may be carried out simultaneously. In other words, the sheet may be drawn after formation of the cylindrical lenses, or the cylindrical lenses may be formed after the sheet is drawn. Alternatively, the forming of the cylindrical lenses and the drawing of the sheet may be carried out simultaneously using several polishing rolls. In a case where the drawing process is carried out first, the drawing is carried out in the direction of the longitudinal axes of the cylindrical lenses to be subsequently formed, or the cylindrical lenses is formed in alignment with the drawing axis of the sheet.

In a case where the formation of the cylindrical lenses and the drawing are carried out simultaneously using several polishing rolls, various methods can be applied. For example, there is a method of forming grooves for the formation of the cylindrical lenses on at least one roll of the first rolls, or adjusting the drawing ratio by narrowing the gap between the last rolls for forming the sheet as mentioned above for raising the pressure or raising the take-up speed of the sheet from the last rolls.

A drawing ratio of not less than 110% is preferable. The drawing ratio is represented as “(sheet thickness before drawing/sheet thickness after drawing)×100 (%)”. When the ratio is not less than 110%, the spherical or quasi-spherical light diffusion agent may be formed into oval shapes more certainly, in addition to which the agent is more likely to be oriented in the drawing direction. However, if the draw is excessive, the strength of the light diffuser plate may possibly be weakened. The drawing ratio is therefore preferably is not more than 400%, and more preferably not more than 300%. The sheet thickness before drawing in the above formula when using three rolls for the drawing process can be thought to be the same as the gap between the first and second rolls just after extrusion.

The backlight unit of the present invention is characterized in comprising the light diffuser plate according to the present invention and a cold cathode fluorescent lamp; wherein the light diffuser plate and the cold cathode fluorescent lamp are positioned to match a length direction of the cylindrical lenses with a length direction of the cold cathode fluorescent lamp.

A cold cathode fluorescent lamp (CCFL) is generally tubular shaped. Accordingly, if the number of CCFLs is reduced in order to cut the producing costs of LCD devices, although no problems arise in the longitudinal direction of c CCFL, it is possible that problems may arise with drops in luminance between the CCFLs or with lamp image. However, the light diffuser plate of the present invention can diffuse light selectively in a specified direction, so even if the number of CCFLs is reduced, the evenness of the light can be maintained. Specifically, by positioning the light diffuser plate of the present invention so that the light diffuser plate is in line with the longitudinal direction of the CCFLs, light can be selectively diffused perpendicular to the longitudinal direction of the CCFLs, allowing the evenness of the light to be maintained.

Accordingly, by using the light diffuser plate of the present invention and the backlight unit having the light diffuser plate, producing costs of LCD devices can be reduced.

### Examples

Hereinafter, the present invention is explained in more detail with reference to Examples. The present invention should not be naturally limited by the following Examples, and can be carried out after appropriate modification within the range compatible with the spirit of the description above and below. Such a modification is embraced by the technical scope of the present invention.

### Example 1

### The Light Diffuser Plate of the Present Invention

(1) Production of Crosslinked Organic Fine Particle

A solution of 1 part by mass of an ammonium salt of polyoxyethylenedistyryl phenyl ether sulfuric acid ester (product name: Hitenol® NF-08 manufactured by Daiichi Kogyo Seiyaku Co. Ltd.) dissolved in de-ionized water of 100 parts by mass was charged in a flask equipped with an agitator (T.K. homogenizer manufactured by Tokushu Kika Industries Co. Ltd.), a nitrogen gas duct, recirculation cooling equipment and a thermometer. Next, methyl methacrylate as a monomer of 99 parts by mass, ethylene glycol dimethacrylate as a crosslinking agent of 1 part by mass and laurel peroxide of 2 parts by mass were added thereto. The reaction mixture was stirred at 3,500 rpm for five minutes at room temperature. Next, the reaction mixture was heated to 65° C. while nitrogen gas was blown into the mixture and a polymerization reaction was carried out for four hours at 65° C. The mixture was then cured for two hours at 75° C. Next, the obtained suspension was cooled down to room temperature and the crosslinked polymer was separated by filtration. The crosslinked organic particle was obtained by drying the resulting crosslinked polymer at 65° C. for 20 hours with a hot air dryer (manufactured by Yamato Scientific). The granular distribution of the particles was measured with precision granularity distribution measuring equipment (Coulter Multisizer III manufactured by Beckman Coulter); as a result, the median diameter was 7.3 μm and the coefficient of variation (CV) was 40.5%. The crosslink density of the particle was 0.0119% as derived from the formula (1) of the present invention.

(2) Production of Light Diffuser Plate

The crosslinked organic particle obtained as described above was mixed into the transparent thermoplastic resins according to the conditions of Table 1 to yield the mixture for the light diffuser plate. The mixtures for light diffuser plate were then fed into an extruder at the rate of 200 kg/hour and then were extruded using three polishing rolls so that a group of cylindrical lenses with a linear rib-shape were formed on one surface while the other surface was given a mirror or embossed finish in accordance with the conditions for formation in Table 2. In the process, a light diffuser plate on whose surface cylindrical lenses were formed was obtained by raising the relative speed of rotation of the third polishing roll with respect to the second polishing roll, and further by raising the speed of rotation of the take-up roll with respect to the third polishing roll to draw the sheet in the longitudinal direction of the cylindrical lenses at separation from the third roll. The width of the light diffuser plate thus obtained was between 70 to 90 cm, and the light diffuser plate was cut in the direction of the drawing at a length of 100 cm.

Details of the rolls used for forming a group of linear rib-shaped cylindrical lenses in Table 2 were as follows.

Roll A had a succession of ridges in the direction of the circumference of the surface layer. The cross section of the ridge was an isosceles triangle with an apex of 90 degrees and a base of 200 μm and corners at the apex and valley were rounded into an arc of 65 μm.

Roll B had a succession of ridges in the direction of the circumference of the surface layer. The cross section of the ridge was a concave semicircle with a width of 200 μm and a depth of 100 μm.

When Roll A was used, cylindrical lenses of isosceles triangle cross sectional shape was formed on one side, and when Roll B was used, cylindrical lenses of semicircular cross section shape was formed on one side. The drawing ratio in Table 2 was calculated from the formula: (x/y)×100 (%) [wherein, x (mm) represents the gap between the first roll and the second roll, and y (mm) represents the thickness of the light diffuser plate obtained after drawing]. In addition, the thickness of the light diffuser plate was measured at the convex part of the surface.

### Example 2

### Production of the Light Diffuser Plate of the Present Invention

A crosslinked organic particle was obtained by the same method as the above Example 1(1) except that methyl methacrylate of 70 parts by mass and n-butyl acrylate of 28 parts by mass were used in place of methyl methacrylate of 99 parts by mass as a monomer, 2 parts by mass of ethyleneglycol dimethacrylate was used as a crosslinking agent, and drying was carried out at 55° C. for 24 hours. The granularity distribution of the obtained crosslinked organic particle was measured in the same method as the above Example 1; as a result, the median diameter was 7.4 μm and the coefficient of variation was 40.2%. In addition, the crosslink density of the particle, measured using formula (1) of the present invention, was 0.0202%.

Using the obtained crosslinked organic particle, the light diffuser plate was produced under the formation condition shown in Table 2 in the same manner as the above Example 1(2).

### Example 3

### Production of the Light Diffuser Plate of the Present Invention

A crosslinked organic particle was obtained by the same method as the above Example 1(1) except that methyl methacrylate of 85 parts by mass and n-butyl acrylate of 14.5 parts by mass were used in place of methyl methacrylate of 99 parts by mass as a monomer, 0.5 parts by mass of ethyleneglycol dimethacrylate was used as a crosslinking agent, further a sulfur antioxidizing agent (pentaerythrityl tetrakis (3-laurylthiopropionate, product name: ADK STAB® AO-4125, manufactured by ADEKA corporation)) of 0.5 parts by mass was added, the mixture was stirred at 3,000 rpm at room temperature for five minutes, and drying was carried out at 50° C. for 24 hours. The granularity distribution of the obtained crosslinked organic particle was measured in the same manner as the above Example 1; as a result, the median diameter was 10.5 μm and the coefficient of variation was 40.8%. In addition, the crosslink density of the particle, measured using formula (1) of the present invention, was 0.0050%.

Using the obtained crosslinked organic particle, the light diffuser plate was produced under the formation condition shown in Table 2 in the same manner as the above Example 1(2).

### Example 4

### Production of the Light Diffuser Plate of the Present Invention

A crosslinked organic particle was obtained by the same method as the above Example 1(1) except that n-butyl methacrylate of 60 parts by mass and n-butyl acrylate of 30 parts by mass were used in place of methyl methacrylate of 99 parts by mass as a monomer, 10 parts by mass of ethyleneglycol dimethacrylate was used as a crosslinking agent, and drying was carried out at 40° C. for 24 hours under reduced-pressure atmosphere of 100 mmHg. The granularity distribution of the obtained crosslinked organic particle was measured in the same manner as the above Example 1; as a result, the median diameter was 7.8 μm and the coefficient of variation was 41.2%. In addition, the crosslink density of the particle, measured using formula (1) of the present invention, was 0.1009%.

Using the obtained crosslinked organic particle, the light diffuser plate was produced under the formation condition shown in Table 2 in the same manner as the above Example 1(2).

### Example 5

### Production of the Light Diffuser Plate of the Present Invention

A crosslinked organic particle was obtained by the same method as the above Example 1(1) except that n-butyl methacrylate of 98 parts by mass was used in place of methyl methacrylate of 99 parts by mass as a monomer, trimethylolpropane tri(meth)acrylate of 2 parts by mass was used as a crosslinking agent, and drying was carried out at 40° C. for 24 hours under reduced-pressure atmosphere of 100 mmHg. The granularity distribution of the obtained crosslinked organic particle was measured in the same manner as the above Example 1; as a result, the median diameter was 7.8 μm and the coefficient of variation was 39.4%. In addition, the crosslink density of the particle, measured using formula (1) of the present invention, was 0.0176%.

Using the obtained crosslinked organic particle, the light diffuser plate was produced under the formation condition shown in Table 2 in the same manner as the above Example 1(2).

### Example 6

### Production of the Light Diffuser Plate of the Present Invention

A crosslinked organic particle was obtained by the same method as the above Example 1(1) except that methyl methacrylate of 79 parts by mass and n-butyl acrylate of 20 parts by mass were used in place of methyl methacrylate of 99 parts by mass as a monomer, 1 part by mass of ethyleneglycol dimethacrylate was used as a crosslinking agent, the mixture was stirred at 6,000 rpm at room temperature for five minutes, and drying was carried out at 55° C. for 24 hours. The granularity distribution of the obtained crosslinked organic particle was measured in the same manner as the above Example 1; as a result, the median diameter was 4.2 μm and the coefficient of variation was 39.8%. In addition, the crosslink density of the particle, measured using formula (1) of the present invention, was 0.0101%.

Using the obtained crosslinked organic particle, the light diffuser plate was produced under the formation condition shown in Table 2 in the same manner as the above Example 1(2).

### Example 7

### Production of the Light Diffuser Plate of the Present Invention

(1) Production of Crosslinked Organic Particle

A crosslinked organic particle was obtained by the same method as the above Example 1(1) except that methyl methacrylate of 79.7 parts by mass and n-butyl acrylate of 20 parts by mass were used in place of methyl methacrylate of 99 parts by mass as a monomer, 0.3 parts by mass of ethyleneglycol dimethacrylate was used as a crosslinking agent, the mixture was stirred at 6,000 rpm at room temperature for five minutes, and drying was carried out at 50° C. for 24 hours. The granularity distribution of the obtained crosslinked organic particle was measured in the same manner as the above Example 1; as a result, the median diameter was 3.8 μm and the coefficient of variation was 40.7%. In addition, the crosslink density of the particle, measured using formula (1) of the present invention, was 0.0030%.

(2) Production of Light Diffuser Plate

The crosslinked organic particle obtained as described above was mixed into the transparent thermoplastic resin according to Blending condition 7 of Table 1 to yield the mixture for the light diffuser plate. Extrusion molding was carried out using the mixture for light diffuser plate, the extruder used in the above Example 1(1) and three polishing rolls, so that a group of cylindrical lenses with a linear rib-shape were formed on one surface while the other surface was given a mirror finish in accordance with the condition for formation in Table 2. In the process, a light diffuser plate on whose surface cylindrical lenses were formed was obtained by raising the relative speed of rotation of the third polishing roll with respect to the second polishing roll, to draw the sheet in the longitudinal direction. The width of the light diffuser plate thus obtained was between 70 to 90 cm, and the light diffuser plate was cut in the direction of the drawing at a length of 100 cm.

### Example 8

### Production of the Light Diffuser Plate of the Present Invention

Using the crosslinked organic particle obtained in the above Example 7, the light diffuser plate was produced with the blending ratio of Blending condition 8 described in Table 1 under the formation condition shown in Table 2 in the same manner as the above Example 7(2).

### Example 9

### Production of the Light Diffuser Plate of the Present Invention

(1) Production of Crosslinked Organic Particle

A crosslinked organic particle was obtained by the same method as the above Example 1(1) except that trifluoroethyl methacrylate of 99 parts by mass was used in place of methyl methacrylate of 99 parts by mass as a monomer, 1 part by mass of ethyleneglycol dimethacrylate was used as a crosslinking agent, and the mixture was stirred at 5,000 rpm at room temperature for five minutes. The granularity distribution of the obtained crosslinked organic particle was measured in the same manner as the above Example 1; as a result, the median diameter was 5.1 μm and the coefficient of variation was 39.2%. In addition, the crosslink density of the particle, measured using formula (1) of the present invention, was 0.0074%.

(2) Production of Light Diffuser Plate

The crosslinked organic particle obtained as described above was mixed into the transparent thermoplastic resin according to Blending condition 9 of Table 1 to yield the mixture for the light diffuser plate. The mixture for light diffuser plate was then fed into the extruder used in the above Example 1 at the rate of 200 kg/hour while the polycarbonate resin without a crosslinked organic particle, obtained by blending a process-heat stabilizing agent (IRGAFOS168 manufactured by Ciba specialty chemicals) of 0.1 part by mass into polycarbonate resin (Eupilon E2000FN manufactured by Mitsubishi engineering-plastics corporation) of 100 parts by mass was fed into a sub-extruder at the rate of 20 kg/hour, and the resins were extruded from a T-die through a feedblock. Extrusion molding was carried out using three polishing rolls so that a group of cylindrical lenses with a linear rib-shape consisting of the transparent thermoplastic resin without a crosslinked organic particle were formed on one surface while the other surface was given a mirror finish in accordance with the condition of Table 2. In the process, a light diffuser plate on whose surface cylindrical lenses were formed was obtained by raising the relative speed of rotation of the third polishing roll with respect to the second polishing roll, to draw the sheet in the longitudinal direction of the cylindrical lenses at separation from the third roll.

To the mixture for light diffuser plate of 100 parts by mass of Blending condition 1 which has a polycarbonate resin base, 30 ppm of a fluorescent whiteness enhancer (Ubitex OB manufactured by Ciba Speciality Chemical Co. Ltd.) was added. The mixture was fed into the above extruder at the rate of 200 kg/hr, while a mixture of polymethyl methacrylate resin (ACRYPET MD manufactured by Mitsubishi Rayon) of 100 parts by mass, a UV absorption agent (Ubinal 3030 manufactured by BASF) of 3 parts by mass and an anti-static agent (TPAE-H471EP manufactured by Fuji Kasei) was fed to a sub-extruder at the rate of 15 kg/hr, and was extruded from T-die through a feedblock. Using the obtained multilayer sheet, a polycarbonate light diffuser plate with cylindrical lenses which light diffuser plate had a layer which was mainly constructed of polymethyl methacrylate resin and also into which no crosslinked organic particle was mixed on the opposite side of the side on which the cylindrical lenses were formed was produced in the same manner as the above Example 1(2) under the formation condition shown in Table 2.

### Example 11

A light diffuser plate with cylindrical lenses which light diffuser plate had a layer which was mainly constructed of polycarbonate resin and also into which no crosslinked organic particle was mixed on the opposite side of the side on which the cylindrical lenses were formed was produced by the same method as the above Example 10 except that polycarbonate resin (Eupilon E2000FN manufactured by Mitsubishi engineering-plastics corporation) in place of polymethyl methacrylate resin was used.

### Example 12

To the mixture for light diffuser plate of 100 parts by mass of Blending condition 1 which has a polycarbonate resin base, 300 ppm of a fluorescent whiteness enhancer (Ubitex OB manufactured by Ciba Speciality Chemical Co., Ltd.) was added. The mixture was fed into the extruder used in the above Example 1(2) at the rate of 200 kg/hr. Separately, polycarbonate resin (Eupilon E2000FN manufactured by Mitsubishi engineering-plastics corporation) of 100 parts by mass, a UV absorption agent (TINUVIN32 manufactured by Ciba specialty chemical) of 5 parts by mass and a process-heat stabilizer (IRGAFOS168 manufactured by Ciba specialty chemical) of 0.1 part by mass were mixed. The mixture was fed to a sub-extruder at the rate of 10 kg/hr at the same time. A multilayer sheet was extruded from T-die through a feedblock. The multilayer sheet was drawn by the same molding condition as the Example 1 of Table 2 except that the rotational ratio of the third polishing roll and the roll for take-up was reduced so that the drawing ratio was 120%. As a result, a polycarbonate light diffuser plate with cylindrical lenses of which light diffuser plate had a thickness of 1.20 mm and a layer into which no crosslinked organic particle was mixed on the opposite side of the side on which the cylindrical lenses were formed was produced.

### Comparative Example 1

### Production of a Light Diffuser Plate

A crosslinked organic particle was obtained by the same method as the above Example 1(1) except that methyl methacrylate of 85 parts by mass was used in place of methyl methacrylate of 99 parts by mass as a monomer and 15 parts by mass of ethyleneglycol dimethacrylate was used as a crosslinking agent. The granularity distribution of the obtained crosslinked organic particle was measured in the same manner as the above Example 1; as a result, the median diameter was 7.2 μm and the coefficient of variation was 40.3%. In addition, the crosslink density of the particle was measured using formula (1) of the present invention, and it was found that the particle was excessively crosslinked since the density was 0.1513%.

Using the crosslinked organic particle obtained in the above, the light diffuser plate was produced with the blending ratio of Blending condition 10 described in Table 1 under the formation condition shown in Table 2 in the same manner as the above Example 1(2). The underlined parts in Table 1 are outside the scope of the present invention.

### Comparative Example 2

### Production of a Light Diffuser Plate

A crosslinked organic particle was obtained by the same method as the above Example 1(1) except that methyl methacrylate of 99.92 parts by mass was used in place of methyl methacrylate of 99 parts by mass as a monomer and 0.08 parts by mass of ethyleneglycol dimethacrylate was used as a crosslinking agent. The granularity distribution of the obtained crosslinked organic particle was measured in the same manner as the above Example 1; as a result, the median diameter was 7.4 μm and the coefficient of variation was 40.9%. In addition, the crosslink density of the particle was measured using formula (1) of the present invention, and it was found that the particle was not sufficiently crosslinked since the crosslinking density was 0.0003%.

Using the obtained crosslinked organic particle, the light diffuser plate was produced with the blending ratio of Blending condition 11 described in Table 1 under the formation condition shown in Table 2 in the same manner as the above Example 1(2).

TABLE 1

| | Transparent | | | | | |
|---|---|---|---|---|---|---|
| | thermoplastic resin | | Crosslinked organic particle | | Antioxidizing agent | |
| | Component | Parts by mass | Crosslink density | Parts by mass | Component | Parts by mass |
| Blending | PC | 99.2 | 0.0119% | 0.8 | phosphate type | 0.1 |
| condition 1 | | | | | | |
| Blending | PC | 99 | 0.0202% | 1 | phosphate type | 0.1 |
| condition 2 | | | | | | |
| Blending | PS | 98.5 | 0.0050% | 1.5 | phosphate type | 0.1 |
| condition 3 | | | | | | |
| Blending | PC | 99 | 0.1009% | 1 | phosphate type | 0.1 |
| condition 4 | | | | | | |
| Blending | PS | 99 | 0.0176% | 1 | phosphate type | 0.1 |
| condition 5 | | | | | | |
| Blending | PC | 99.2 | 0.0101% | 0.8 | phosphate type | 0.1 |
| condition 6 | | | | | | |
| Blending | PS | 99.2 | 0.0030% | 0.8 | phosphate type | 0.1 |
| condition 7 | | | | | | |
| Blending | COP | 99.2 | 0.0030% | 0.8 | phosphate type | 0.1 |
| condition 8 | | | | | | |
| Blending | PC | 99.5 | 0.0074% | 0.5 | phosphate type | 0.1 |
| condition 9 | | | | | | |
| Blending | PC | 99.2 | 0.1513% | 0.8 | phosphate type | 0.1 |
| condition 10 | | | | | | |
| Blending | PS | 98.5 | 0.0003% | 1.5 | phosphate type | 0.1 |
| condition 11 | | | | | | |

PC: Polycarbonate resin (Eupilon E2000FN manufactured by Mitsubishi engineering-plastics corporation)
PS: Polystyrene resin (SGP-1 manufactured by PS Japan)
COP: Cycloolefin resin (TOPAS6013 manufactured by Ticona)
Phosphate antioxidizing agent (IRGAFOS168 manufactured by Ciba supeciality chemicals)

TABLE 2

| | | Extrude | The 1st roll | The 2nd roll | | The 3rd roll | | Drawing | Thickness |
|---|---|---|---|---|---|---|---|---|---|
| | | temperture | temperature | | Temperature | | Temperature | ratio | of diffuser |
| | Composition | (° C.) | (° C.) | Surface | (° C.) | Type | (° C.) | (%) | (mm) |
| Example 1 | Blending | 280 | 140 | mirror | 170 | B | 180 | 200 | 1.20 |
| | condition 1 | | | | | | | | |
| Example 2 | Blending | 280 | 140 | mirror | 170 | A | 180 | 150 | 1.19 |
| | condition 2 | | | | | | | | |
| Example 3 | Blending | 190 | 90 | mirror | 120 | B | 130 | 180 | 1.20 |
| | condition 3 | | | | | | | | |
| Example 4 | Blending | 280 | 140 | embossed | 170 | B | 180 | 180 | 1.20 |
| | condition 4 | | | | | | | | |
| Example 5 | Blending | 190 | 90 | embossed | 120 | A | 130 | 200 | 1.21 |
| | condition 5 | | | | | | | | |
| Example 6 | Blending | 280 | 140 | embossed | 170 | B | 180 | 180 | 1.20 |
| | condition 6 | | | | | | | | |
| Example 7 | Blending | 190 | 90 | embossed | 120 | B | 130 | 150 | 1.20 |
| | condition 7 | | | | | | | | |
| Example 8 | Blending | 230 | 120 | embossed | 150 | B | 160 | 180 | 1.18 |
| | condition 8 | | | | | | | | |
| Example 9 | Blending | 280 | 140 | embossed | 170 | B | 180 | 180 | 1.18 |
| | condition 9 | | | | | | | | |
| Example 10 | Blending | 280 | 140 | mirror | 170 | B | 180 | 200 | 1.20 |
| | condition 1 + | | | | | | | | |
| | Fluorescent | | | | | | | | |
| | whiteness enhancer | | | | | | | | |
| Comparative | Blending | 280 | 140 | mirror | 170 | B | 180 | 200 | 1.20 |
| example 1 | condition 10 | | | | | | | | |
| Comparative | Blending | 190 | 90 | mirror | 120 | B | 130 | 180 | 1.21 |
| example 2 | condition 11 | | | | | | | | |

Test 1: Evaluation of the Shape and Orientation Degree of the Crosslinked Organic Particle in the Light Diffuser Plate

The shape and orientation degree of the crosslinked organic particles were evaluated by observing 100 μm×100 μm regions at the centers and at a distance 1/10^{th} from the left and right edges of Examples 1 to 3 and Comparative examples 1 and 2 from the mirror side with an optical microscope. In addition, the centers of the light diffuser plate s were cut vertically in line with the longitudinal axis of the cylindrical lenses, and the shape and orientation degree of the crosslinked organic particles were evaluated by the same manner at the centers and at a distance 1/10^{th} away from the left and right edges respectively. The results of the evaluations are shown in Table 3. In the “crosslinked organic particle shape” column of Table 3, the numerical value shows the aspect ratio of the oval or circular shape, “-” indicates that the existence of particles could not be clearly ascertained; and in the “orientation degree of the crosslinked organic particle” column, “good” indicates that the longitudinal axis of the particles was more or less aligned with the longitudinal direction of the cylindrical lenses, while “-*¹” indicates that the orientation could not be seen since the shape of the crosslinked organic particles was almost circular, and “-*²” indicates that the existence of particles could not be accurately established.

TABLE 3

| | | Position for observation | | | | | |
|---|---|---|---|---|---|---|---|
| | | At a distance 1/10 | | | | At a distance 1/10 | |
| | | from the right edge | | Center of width | | from the left edge | |
| | | Shape of the | Orientation degree | Shape of the | Orientation degree | Shape of the | Orientation degree |
| | Direction for | crosslinked | of the crosslinked | crosslinked | of the crosslinked | crosslinked | of the crosslinked |
| | observation | organic particle | organic particle | organic particle | organic particle | organic particle | organic particle |
| Example 1 | from mirror side | 3.2 to 3.8 | good | 3.2 to 3.8 | good | 3.2 to 3.8 | good |
| | from cross-section | 3.2 to 3.8 | good | 3.2 to 3.8 | good | 3.2 to 3.8 | good |
| Example 2 | from mirror side | 2.5 to 3.0 | good | 2.5 to 3.0 | good | 2.5 to 3.0 | good |
| | from cross-section | 2.5 to 3.0 | good | 2.5 to 3.0 | good | 2.5 to 3.0 | good |
| Example 3 | from mirror side | 3.0 to 3.5 | good | 3.0 to 3.5 | good | 3.0 to 3.5 | good |
| | from cross-section | 3.0 to 3.5 | good | 3.0 to 3.5 | good | 3.0 to 3.5 | good |
| Comparative | from mirror side | about 1 | —*¹ | about 1 | —*¹ | about 1 | —*¹ |
| Example 1 | from cross-section | about 1 | —*¹ | about 1 | —*¹ | about 1 | —*¹ |
| Comparative | from mirror side | — | —*² | — | —*² | — | —*² |
| Example 2 | from cross-section | — | —*² | — | —*² | — | —*² |

As the results shown in Table 3, in the case of Comparative example 1, in which particles whose crosslink density exceeded the range of the present invention were mixed into the thermoplastic resin, the particles did not change shape during the drawing process to form the cylindrical lenses and remained in an almost circular shape. On the other hand, in the case of Comparative example 2, in which particles whose crosslink density fell below the range of the present invention were mixed into the thermoplastic resin, the particles probably dissolved into the matrix thermoplastic resin when dispersed into the resin, resulting in that the particles lost the original shape thereof and thus the existence was unable to be detected.

On the other hand, in the case of Examples 1 to 3, whose crosslink densities were within the range of the present invention, about 30 to 50 crosslinked organic particles were present in the 100×100 μm region observed from the mirror side, while about 30 to 50 crosslinked organic particles were similarly observed from the cylindrical lenses' longitudinal cross section. Also, in each observation, all the crosslinked organic particles were deformed into an oval shape in the drawing direction, i.e. the cylindrical lenses' longitudinal direction. Also, the longitudinal axes of almost all the crosslinked organic particles were almost identical with the drawing direction, and the angle of both was not more than 5 degrees at most. The above results were thought to be due to the fact that the crosslinked organic particles according to the present invention remained unchanged in spherical shape thereof when the particles were dispersed into the molten thermoplastic resin, but changed shape due to the shear forces occurred when the cylindrical lenses were formed by drawing. From the above results, the light diffuser plate of the present invention is able to diffuse light well in the direction perpendicular to the cylindrical lenses.

Test 2: Evaluation of the Optical Performance

A light diffuser plate with cylindrical lenses was attached to a 200 mm square CCFL backlight so that the lens surface was on the light emitting side. The backlight had a reflecting sheet, and the lamp pitch thereof was 32 mm. The luminance of 10 spots over the CCFLs and between the CCFLs respectively were measured using a spectroradiometer (SR-3A manufactured corporation), and the average value and evenness of the luminance were obtained. The luminance evenness was calculated from the following formula: {Lₘᵢₙ(minimum luminance)/Lₘₐₓ(maximum luminance)}×100(%). The results are shown in Table 4, in which the case that the luminance evenness is less than 85% is indicated as “bad”, between 85% and less than 90% as “not good”, 90% or more but less than 95% as “good” and 95% or more as “very good”.

TABLE 4

| | Average of luminance | Evenness of luminance |
|---|---|---|
| Example 1 | 7785 | good |
| Example 2 | 7450 | very good |
| Example 3 | 7240 | very good |
| Example 4 | 7565 | very good |
| Example 5 | 7525 | very good |
| Example 6 | 7680 | very good |
| Example 7 | 7430 | very good |
| Example 8 | 7515 | good |
| Example 9 | 7855 | good |
| Example 10 | 7740 | very good |
| Example 11 | 7765 | very good |
| Example 12 | 7750 | good |
| Comparative example 1 | 7950 | bad |
| Comparative example 2 | 7020 | not good |

As the result of Table 4, in the case of the light diffuser plate of Comparative example 1 in which the crosslinked organic particles were dispersed in almost unchanged spherical shape, the luminance was high, since the light could easily pass through; however, the evenness of the luminance was quite inadequate because of the poor effect of the optical diffusion anisotropy due to the organic particles. In addition, in the case of the light diffuser plate of Comparative example 2 whose organic particles could not be observed, the luminance was reduced and the transparency of the light diffuser plate was lowered, since the organic particles were possibly dissolved into the matrix resin. The luminance evenness was not also sufficient.

On the other hand, in the case of the light diffuser plate according to the present invention, the shone light was first diffused in the direction perpendicular to the cylindrical lenses by the crosslinked organic particles, since the crosslinked organic particles were deformed in approximately the same direction as the longitudinal axes of the cylindrical lenses; and further diffused in the same direction by the cylindrical lenses. As a result, the light diffuser plate of the present invention is superlative as an LCD component, since the luminance evenness becomes extremely high.

### INDUSTRIAL APPLICABILITY

The light diffuser plate of the present invention has high optical diffusion anisotropy, since the crosslinked organic particle with light diffusion property do not change shape during the dispersion process into the matrix resin, but change into the desired shape during the drawing process, when the light diffuser plate is produced. Accordingly, the light diffuser plate of the present invention can diffuse light in any desired direction even if the number of CCFLs in the backlight is reduced. Therefore, the present invention is extremely advantageous from an industrial perspective in exhibiting high luminance while reducing the producing cost of LCD devices, demand for which is growing.

1. A light diffuser plate,
comprising a light diffusion layer containing a thermoplastic resin and a crosslinked organic fine particle dispersed in the thermoplastic resin, and a cylindrical lens array on at least one side;
wherein,
a refractive index of the crosslinked organic fine particle is different from a refractive index of the thermoplastic resin;
a crosslink density defined by a following formula (1) of a polymer constituting the crosslinked organic fine particle is not less than 0.001% and not more than 0.12%:
$$Crosslink density ( \% ) \frac{\{ Fn ( c ) / Mw ( c ) \} \times \{ W ( c ) \} \times 100}{W ( m ) + W ( c )} \qquad ( 1 )$$
wherein Fn(c) is the number of a crosslinkable functional group of a crosslinking agent used for producing the crosslinked organic fine particle; Mw(c) is a molecular weight of the crosslinking agent used for producing the crosslinked organic fine particle; W(c) is mass % of the crosslinking agent used for producing the crosslinked organic fine particle, relative to a total of a monomer used for producing the crosslinked organic fine particle and the crosslinking agent; W(m) is mass % of the monomer, relative to the total of the monomer and the crosslinking agent;
an aspect ratio of the crosslinked organic fine particle is more than 1; and
a major-axis direction of the crosslinked organic fine particle and a length direction of the cylindrical lenses are the same.

2. The light diffuser plate according to claim 1, wherein at least one of the crosslinked organic fine particle and the thermoplastic resin contains an antioxidizing agent.

3. The light diffuser plate according to claim 1, wherein a layer having an ultraviolet absorbing agent and/or an antistatic agent is comprised.

4. A process for production of a light diffuser plate, comprising steps of:
dispersing a crosslinked organic fine particle in a thermoplastic resin, wherein a crosslink density defined by a following formula (1) of the crosslinked organic fine particle is not less than 0.001% and not more than 0.12%, and a refractive index of the crosslinked organic fine particle is different from a refractive index of the thermoplastic resin,
$$Crosslink density ( \% ) \frac{\{ Fn ( c ) / Mw ( c ) \} \times \{ W ( c ) \} \times 100}{W ( m ) + W ( c )} \qquad ( 1 )$$
wherein Fn(c) is the number of a crosslinkable functional group of a crosslinking agent used for producing the crosslinked organic fine particle; Mw(c) is a molecular weight of the crosslinking agent used for producing the crosslinked organic fine particle; W(c) is mass % of the crosslinking agent used for producing the crosslinked organic fine particle, relative to a total of a monomer used for producing the crosslinked organic fine particle and the crosslinking agent; W(m) is mass % of the monomer, relative to the total of the monomer and the crosslinking agent;
forming the dispersion into a sheet;
forming a cylindrical lens array on at least one side of the sheet; and
uniaxially-stretching the sheet in the same direction as a length direction of the cylindrical lenses.

5. The process according to claim 4, wherein a number average particle size of the crosslinked organic fine particle is not less than 0.5 μm and not more than 100 μm.

6. A backlight unit,
comprising the light diffuser plate according to claim 1 and a cold cathode fluorescent lamp;
wherein the light diffuser plate and the cold cathode fluorescent lamp are positioned to match a length direction of the cylindrical lenses with a length direction of the cold cathode fluorescent lamp.

7. The light diffuser plate according to claim 2, wherein a layer having an ultraviolet absorbing agent and/or an antistatic agent is comprised.
